(19) United States
(12) Patent Application Publication
(10) Pub. No.: US 2006/0237374 A1
(43) Pub. Date: Oct. 26, 2006

(54) Ultrasound apparatus and the manufacture thereof

(75) Inventors: Tony Amato, Kidderminster (GB); Michael John Crane, Kidderminster (GB)

Correspondence Address: NIXON PEABODY, LLP, 401 9TH STREET, NW, SUITE 900, WASHINGTON, DC, 20004-2128, US

(73) Assignee: Sonico Limited, Kidderminster (GB)

(21) Appl. No.: 10/534,124

(22) PCT Filed: Nov. 7, 2003
(86) PCT No.: PCT/GB03/04826

§ 371 Date: Nov. 18, 2005

(30) Foreign Application Priority Data
Nov. 8, 2002 (GB) 0226174.1

(51) Int. Cl. C02F 1/32

(52) U.S. Cl. 210/748

(57) ABSTRACT

The present invention concerns apparatus for applying ultrasonic energy which comprises an applicator (1) having an outwardly facing surface, the apparatus further including an extender (6) which extends from the outwardly facing surface, and at least one booster (7) at the end of the extender remote from the applicator for boosting ultrasonic energy applied thereto to cause the applicator to oscillate, wherein the applicator, extender and booster are integrally formed. The invention also concerns the manufacture of the apparatus.

The present invention relates to apparatus for applying ultrasonic energy, and to a method of manufacturing the same.

Ultrasonic energy can be applied to a material or device to be processed. For example, ultrasonic energy has been used to treat sewage, the ultrasonic energy being applied to one or more suitably shaped horns exposed to liquid sewage slurry. The amount of energy applied to the material or device should be maximised in order to efficiently implement a desired process. For example, for sewage treatment, the ultrasonic energy should preferably be applied so as to cause cavitation in the sewage slurry, to thereby promote breakdown of the slurry.

Ultrasonic energy can also be used for other applications, for example plastic welding, and cutting.

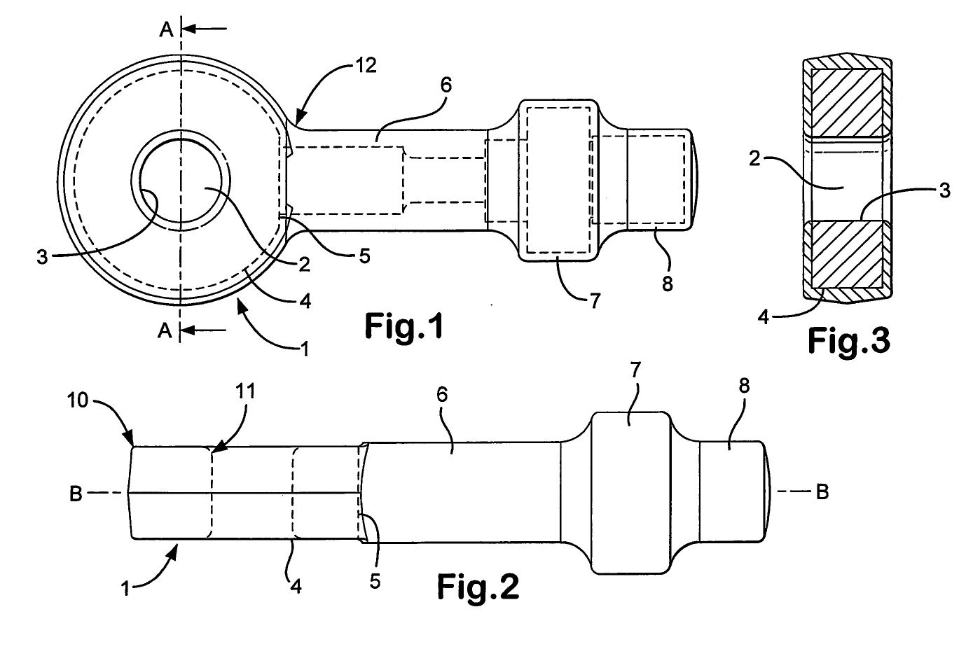

An ultrasonic horn found to be particularly beneficial in the treatment of sewage slurry is that shown in FIGS. 1, 2 and 7 of UK patent number 2 285 142, wherein a toroidal applicator is driven into radial ultrasonic oscillations by means of an electro-acoustic generator. The electro-acoustic generator is connected to a flat region formed on the outer surface of the applicator by way of a booster and an extender leg disposed radially with respect to the applicator.

Such a toroidal applicator is of particular utility in the treatment of slurries such as sewage, since the applied ultrasonic energy can be coupled efficiently thereto, causing the inner and outer surfaces to vibrate radially at the applied ultrasonic frequency, whilst the slurry passes through both the central aperture and over the outer surface.

It is known for a plurality of such applicators to be stacked with their central apertures aligned, and for the slurry to be pumped or otherwise caused to flow through and around them in series. It is also known for individual applicators to be driven by more than one electro-acoustic generator, in order to increase the energy that can be applied to the applicator and hence imparted to the slurry. Nevertheless, the application of ultrasonic energy in sufficient quantities to drive such applicators at the intensity levels required, for example for the treatment of sewage, can place considerable demands upon the construction techniques used to fabricate the horns. The energy demands of such applications can also lead to horn damage or failure, which may require shut-down of the processing plant, and time consuming repair and/or replacement of equipment.

The present invention seeks to provide apparatus for applying ultrasonic energy and a method for manufacturing the same which can overcome the aforementioned difficulties.

According to the present invention there is provided apparatus for applying ultrasonic energy to sewage slurry which comprises an applicator having an outwardly facing surface, the apparatus further including an extender which extends radially from the outwardly facing surface, and one or more boosters at the end of the extender remote from the applicator for boosting ultrasonic energy applied thereto to cause the applicator to oscillate, wherein the applicator, extender and booster are integrally formed.

Herein the term “integrally formed” means that the applicator, extender and booster are manufactured as a single piece, as opposed to being manufactured as separate pieces and subsequently bolted, welded, or otherwise attached together. Hereinafter, the applicator, extender and booster will collectively be referred to as the “integral components”.

Thus, apparatus for applying ultrasonic energy of this general kind have hitherto been manufactured by providing the applicator, the extender and the booster as separate components and securing them together, for example by bolting or welding. However, in practice such known devices tend to fail by separation of components at their points of attachment to one another, especially when subjected for protracted periods to the destructive impact of ultrasonic oscillations at the energy levels required, for example, to process sewage.

With the apparatus of the present invention, the benefits of integral construction, for example longevity and reduced servicing requirements, significantly outweigh the loss of design and operational flexibility associated with integral formation of the integral components. In this respect, the incorporation of the booster as an integral component is particularly surprising since the booster has traditionally been used to determine the delivered amplitude from the apparatus. For example, the booster can be adapted to operational and environmental changes, and for different ultrasonic generators, either as replacements for failed equipment, to condition the apparatus to process different materials, or to change its effect on a given material.

Conventional apparatus tend to fail at the first attachment interface between the radial horn and first booster plus extender, because of the high energies and transitioni from longitudinal to radial vibration prevailing there.

The applicator may be any suitable shape, for example it may be a block, plate, rod or cylindrical in structure, and/or may have rounded, tapered, fluted, castellated, flared or bell-shaped portions. However, the applicator preferably has a central aperture defined by an inwardly facing surface. The inwardly facing surface of the applicator preferably oscillates when ultrasonic energy is applied to the apparatus.

The integral components should be made of a suitable material for imparting ultrasonic energy to a material or device to be treated, for example sewage slurry. In preferred apparatus of the present invention the integral components are formed from a rolled forged, or cast, material.

Suitable materials for forming the integral components include metals, for example alloys for casting or forging into the desired shape. Preferred metals are titanium-containing alloys, in particular titanium-aluminium-containing alloys, due to their relatively high strength and low density. A particularly preferred alloy comprises titanium, aluminium, and vanadium in a molar ratio of 6:4:1.

Other suitable materials for forming the integral components include aluminium and aluminium-containing alloys, steel and steel-containing alloys, and ceramics. However, the particular material of choice with be determined largely on its ultrasonic efficiency, and durability under the prevailing conditions of use.

According to the present invention there is also provided a method of manufacturing apparatus for applying ultrasonic energy, which apparatus comprises an applicator having an outwardly facing surface, the apparatus further including an extender which extends radially from the outwardly facing surface, and one or more boosters at the end of the extender remote from the applicator for boosting ultrasonic energy applied thereto to cause the applicator to oscillate, the method comprising integrally forming the applicator, extender and booster by a forging and/or casting process.

The process used to integrally form the integral components may comprise a forging process, for example cold forging, hot forging and enclosed forging, a casting process, for example mould casting, die casting and low- or high-pressure casting, and/or other suitable processes known to those persons skilled in the art, for example extrusion or vacuum consumable arc electrode furnace processes.

The particular manufacturing process to integrally form the integral components will depend upon the particular requirements of the apparatus in question, and hence the desired properties of the integral components, as will be apparent to those skilled in the art.

For example, typical mould, die and low- and high-pressure casting processes comprise pouring molten metal into casting apparatus to form a cast body, after which the sprue and feeder portions are removed to thereby provide a stock material. Such conventional casting processes have the advantage of low production costs, but can result in casting defects in the cast bodies, such as cavities, pinholes, shrinkage cavities, and oxide build-up. Casting by unidirectional solidification can however provide cast bodies having higher interior metallographic quality.

Alternatively or additionally, in a typical forging process, components are formed by shaping hot metal by means of hammers, presses and the like, in a controlled sequence of production steps, as opposed to random flow of material into desired shapes. Forged components can have relatively high directional alignment (grain flow), which influences strength, ductility and resistance to impact and fatigue, impact strength, structural integrity (due to the substantial absence of internal gas pockets or voids), strength to weight ratio, and response to heat treatment compared to components formed by other manufacturing processes.

The method of the present invention preferably comprises rolling and forging a material to form a component, for example a rod, from which the integral components are formed. The rolled and forged component is then preferably cut to approximate dimensions, and machined to form the integral applicator, extender and booster. In this regard, it has been found that by using forging techniques, the horn is more effective in delivering power to the media in which it operates, affording an increased amplitude of vibration at the operating surfaces of up to 20%, compared with comparable horns driven by the same power source.

A particularly preferred method for manufacturing the integral components for use in the present invention employs a so-called hot isostatic process, or “HIP”. In the HIP, heat and pressure are applied to the material from which the integral components are to be formed in an enclosed vessel. The application of heat softens the material, and by applying pressure thereto the material can be compressed to a higher density. In this way, internal gas pockets and voids can be substantially eliminated from the material, and the end product consequently has a relatively high structural integrity. The heat can be applied to the vessel by, for example resistance elements (e.g. molybdenum resistance elements), and the pressure can be applied, for example, by blowing gas (e.g. an inert gas, such as Argon) into the vessel under high pressure.

The forged and/or cast integral components may be subjected to further treatments. For example, the integral components may be subjected to annealing, electropolishing, PVD coating, ion implantation, carburising, case hardening, carbonitriding, nitriding, nitrocarburing, “Tufftriding”™, induction treatment, and sub-zero treatment.

An embodiment of the present invention will now be described in detail with reference to the accompanying drawings in which:

FIG. 1 is a side elevation of a forged integral component for forming the integral components of an ultrasonic horn of an embodiment of the present invention;

FIG. 2 is a plan view of the component shown in FIG. 1; and

FIG. 3 is a section on line A-A of FIG. 1.

In FIGS. 1, 2 and 3 the unbroken line shows the shape of a component as forged. The broken line shows the final shape of the integral components following machining.

Referring now to the drawings, in which common features are identified by the same reference numbers, a toroidal applicator 1 has a central aperture 2 surrounded by a circular, inwardly facing surface 3. An outwardly facing surface 4 of the applicator 1 is also substantially circular, but is formed with a flattened region 5 from which an integrally formed extender 6 extends substantially radially of the applicator 1.

At the end of the extender 6 remote from the applicator 1, there is an integrally formed flanged booster 7 for both amplifying, or boosting, ultrasonic oscillations applied thereto by means of an electro-acoustic generator (not shown), which is intended to be coupled to the exposed area 8 of the booster region 7 in known manner, and also to allow mounting the ultrasonic apparatus into an industrial application. For example, the apparatus may be mounted by conventional top mounting and sealing with flat gaskets, or by means of a mounting plate for mounting the ultrasonic apparatus to a vessel, the booster being provided on an inwardly orientated face of the mounting plate in relation to the vessel. In this way, the booster projects into the interior of the vessel. Frequencies typically extend from 20 to 35 kHz.

The ultrasonic energy, duly boosted by the extender 6 and booster 7, is conveyed by continuous mechanical contact through the integrally formed components to the applicator 1 where it is effective to cause the inwardly and outwardly facing surfaces 3 and 4 to vibrate radially at the selected operational frequency. Preferably, a fluid medium, such as sewage slurry, to be subjected to the vibrations of the applicator 1, is constrained to flow or to lie within the aperture 2. However, such a fluid medium may also flow around the outwardly facing surface 4 of the applicator 1.

As shown in FIGS. 1 and 2 the edges 10 and 11 of the applicator 1 are radiused. It has in this regard become apparent that these edges are particularly prone to stress and can be weakened by cavitational pitting. By radiusing such edges, for example with a 3 mm radius such stresses can be reduced.

Further, as part of the final finishing process, the area adjoining the applicator 1 and the extender 6 is radiused at surface 12 to minimise cavitational pitting in this area. This surface is a 3-Dimensional interface for which a 15 mm radius is specified in the example of FIG. 1.

If desired, two or more similar apparatus can be stacked with their apertures such as 2 in alignment, and arranged so that a fluid medium to be treated is exposed to each applicator 1 in series. Alternatively, the apertures 1 of the stack can be misaligned, or caused to define a predetermined path, such as a meandering or convoluted path, for the fluid medium.

Furthermore, a given applicator 1 may be integrally formed with two or more extenders 6 and boosters 7, whereby more than one electro-acoustic generator may be coupled to the, each or any applicator 1. In such an arrangement, the extenders 6 preferably meet the applicator 1 at equi-angular spacings, such that, for example, two extenders 6 integrally formed with a common applicator 1 would be disposed facing each other across the applicator 1, thus being spaced at 180 degrees from one another. Three extenders 6 integrally formed with a common applicator 1 would preferably be disposed at 120 degree intervals. Alternatively, two extenders 6 integrally formed with a common applicator 1 could be disposed orthogonally to each other, thus disposed at 90 degree and 270 degree separations around the applicator 1.

In a preferred arrangement, a plurality of apparatus are employed, alternate apparatus being radially aligned. Thus, for an arrangement having five apparatus, the first, third and fifth apparatus may be radially aligned, as may the second and fourth. A particularly preferred arrangement comprises five apparatus, in which the apparatus are radially symmetrically disposed either side of a centre line. More preferably, the first, third and fifth apparatus are substantially in radial alignment disposed on one side of the line, and the second and fourth apparatus are substantially in radial alignment disposed by a substantially equal amount on the other side of the line. In this arrangement, the first, third and fifth, and second and fourth apparatus are preferably radially disposed by substantially 45°.

The forged integral component shown in FIGS. 1, 2 and 3 is made by first forming an oversize component of an alloy comprising titanium, aluminium and vanadium in a molar ratio of 6:4:1, by forging. The die split line is shown in FIG. 2 along line B-B. The forged component approximates the dimensions of the end product integral components, and then is finally machined to form the integral components.

The integral components of the apparatus of the embodiment of the present invention described with reference to the drawings is formed using an HIP process. In the HIP process, heat and pressure are applied to the titanium alloy in an enclosed vessel. The application of heat softens the alloy, and by applying pressure thereto the alloy is compressed to a higher density. In this way, internal gas pockets and voids can be substantially eliminated from the alloy, and the integral components consequently have a relatively high structural integrity. The heat is applied to the vessel by molybdenum resistance elements in the vessel, and the pressure is applied by blowing Argon gas into the vessel under high pressure.

It has been found in this respect that by using forging techniques, the horn is more effective in delivering power to the media in which it operates, affording an increased amplitude of vibration at the operating surfaces of up to 20%, compared with comparable horns driven by the same power source. For example, the horn of the present invention can afford an amplitude of 15 micron at the operating surfaces compared with 12.5 micron of comparable horns.

The forging process by its nature produces a billet that requires further machining before the final product is produced. This process can result in stresses being imparted to the finished product particularly in the areas where machining has been necessary. Hence, after machining the finished horn can be “stress relieved”, using standard processes, an example being maintaining the horn at 538° C. for 2 hours and then allowing it to be air cooled.

It will be understood that the embodiment illustrated shows an application of the invention only for the purposes of illustration. In practice the invention may be applied to many different configurations, the detailed embodiments being straightforward for those skilled in the art to implement.

1. Apparatus for applying ultrasonic energy to sewage slurry which comprises an applicator having an outwardly facing surface, the apparatus further including an extender which extends from the outwardly facing surface, and at least one booster at the end of the extender remote from the applicator for boosting ultrasonic energy applied thereto to cause the applicator to oscillate, wherein the applicator, extender and booster are integrally formed.

2. Apparatus according to claim 1 wherein the applicator has a central aperture defined by an inwardly facing surface.

3. Apparatus according to claim 2 wherein the inwardly facing surface oscillates when ultrasonic energy is applied to the apparatus.

4. Apparatus according to of claim 1 wherein the integral applicator, extender and booster are formed from a rolled forged, or cast, material.

5. Apparatus according to claim 1 wherein the integral applicator, extender and booster are formed from metal.

6. Apparatus according to claim 5 wherein the metal is an alloy.

7. Apparatus according to claim 6 wherein the alloy is a titanium-containing alloy.

8. Apparatus according to claim 5 wherein the alloy is a titanium-aluminium-containing alloy.

9. Apparatus horn according to claim 8 wherein the alloy comprises titanium, aluminium, and vanadium in a molar ratio of 6:4:1.

10. A method of manufacturing apparatus for applying ultrasonic energy, which apparatus comprises an applicator having an outwardly facing surface, the apparatus further including an extender which extends radially from the outwardly facing surface, and at least one booster at the end of the extender remote from the applicator for boosting ultrasonic energy applied thereto to cause the applicator to oscillate, the method comprising integrally forming the applicator, extender and booster by a forging and/or casting process.

11. A method according to claim 10 which comprises cold forging, hot forging, enclosed forging, mould casting, die casting, low- and/or high-pressure casting.

12. A method according to claim 10 comprises rolling and forging a material to form a component from which the integral applicator, extender and booster are formed.

13. A method according to claim 12 wherein the component is cut to approximate dimensions, and then machined to form the integral applicator, extender and booster.

14. A method according to of claim 10 wherein heat and pressure are applied to a material from which the integral applicator, extender and booster are formed in an enclosed vessel.

15. A method according to claim 14 wherein the heat is applied to the vessel by resistance elements.

16. A method according to claim 15 wherein the resistance elements comprise molybdenum resistance elements.

17. (canceled)

18. A method according to claim 17 wherein the gas comprises Argon.

19. (canceled)

20. (canceled)
